(19) United States
(12) Patent Application Publication
(10) Pub. No.: US 2016/0011348 A1
(43) Pub. Date: Jan. 14, 2016

(54) INFRARED CUT FILTER

(71) Applicant: ASAHI GLASS COMPANY, LIMITED, Tokyo (JP)

(72) Inventors: Hideyuki HIRAKOSO, Tokyo (JP); Hiroshi KUMAI, Tokyo (JP); Wakako ITO, Tokyo (JP); Satoshi KASHIWABARA, Tokyo (JP)

(73) Assignee: ASAHI GLASS COMPANY, LIMITED, Tokyo (JP)

(21) Appl. No.: 14/866,029

(22) Filed: Sep. 25, 2015

Related U.S. Application Data
(63) Continuation of application No. PCT/JP2014/060343, filed on Apr. 9, 2014.

(30) Foreign Application Priority Data
Apr. 10, 2013 (JP) 2013-082508
Oct. 21, 2013 (JP) 2013-218631

(51) Int. Cl. G02B 5/20; G02B 1/11; G02B 5/22

(52) U.S. Cl. CPC G02B 5/208; G02B 5/223; G02B 5/226; G02B 5/206; G02B 1/11

(57) ABSTRACT

An infrared cut filter is disclosed. This filter includes a transparent substrate and one or more infrared absorbing layers containing an infrared absorbing compound on at least one principal surface of the transparent substrate, wherein a transmittance at a wavelength of 1200 nm measured in a stack composed of the transparent substrate and the one or more infrared absorbing layers is 10% or less.

CROSS-REFERENCE TO RELATED APPLICATIONS

This application is a continuation of prior International Application No. PCT/JP2014/060343 filed on Apr. 9, 2014 which is based upon and claims the benefit of priority from Japanese Patent Applications Nos. 2013-082508 filed on Apr. 10, 2013 and 2013-218631 filed on Oct. 21, 2013; the entire contents of all of which are incorporated herein by reference.

### TECHNICAL FIELD

Embodiments described herein generally relate to an infrared cut filter.

### BACKGROUND

An imaging apparatus such as a digital still camera images a subject using a solid-state imaging device such as a CCD (Charge Coupled Device), a CMOS (Complementary

Metal Oxide Semiconductor Image Sensor) image sensor. These solid-state imaging devices have a spectral sensitivity from the visible wavelength range to the infrared wavelength range near 1200 nm. Accordingly, the solid-state imaging devices cannot obtain excellent color reproducibility as they are, and therefore need to correct the spectral sensitivity to the normal visibility of a human being through use of a filter that cuts light in the infrared wavelength range (hereinafter, also referred to simply as “infrared light”). Therefore, in an optical path from an imaging lens to the solid-state imaging device, infrared reflecting glass having an infrared reflective film provided on the glass surface is generally disposed.

The infrared reflective film used for such a purpose is required to have a high transmittance for light in the visible wavelength range (hereinafter, also referred to simply as “visible light”). From the viewpoint, a dielectric multilayered film made by alternately stacking a high refractive index material layer and a low refractive index material layer into a plurality of layers is used. Further, a dielectric multilayered film in which at least one layer of the high refractive index material layers or the low refractive index material layers is a transparent conductive material layer is also used. In the latter case, it is possible to keep a high transmittance for the visible light, and absorb the infrared light by the transparent conductive material layer while reflecting unnecessary light in the ultraviolet wavelength range (hereinafter, also referred to simply as “ultraviolet light”) and infrared light.

Further, the glass itself is sometimes constituted of infrared absorbing glass composed of a composition system having an infrared absorption ability. Such infrared absorbing glass is formed by adding CuO to phosphate glass or fluorophosphate glass so as to selectively absorb the light in the infrared wavelength range. This glass contains a large amount of P₂O₅ as an essential component and further contains CuO, and thus forms Cu²⁺ ions coordinated on many oxygen ions in an oxidizing melting atmosphere to exhibit blue-green to provide infrared absorbing characteristics.

However, such existing infrared reflecting glass or infrared absorbing glass is not sufficient in cutting effect to the infrared light in a long wavelength range over 1100 nm, in particular, 1200 nm or more. Therefore, an infrared cut filter is required which is capable of sufficiently effectively cutting the infrared light in a long wavelength range of 1200 nm or more while keeping a high transmittance for the visible light.

Focusing attention only on the cutting effect to the infrared light, for example, it is possible to effectively cut the infrared light with 1200 nm or more by increasing the number of layers, the film thickness or the like of the dielectric multilayered film constituting the infrared reflective film. However, there occurs other problems such as occurrence of warpage in the substrate, decrease in productivity and yield, and increase in manufacturing cost.

### SUMMARY

An object of the present invention is to provide an infrared cut filter capable of sufficiently effectively cutting an infrared light in a long wavelength range of 1200 nm or more while keeping a high transmittance for the visible light, and without causing problems such as warpage of a substrate.

An infrared cut filter according to one aspect of the present invention includes a transparent substrate and one or more infrared absorbing layers on at least one principal surface of the transparent substrate, wherein the infrared absorbing layer is a layer containing an organic dye or an inorganic particle in a transparent resin or a layer composed of an inorganic particle, and wherein a transmittance at a wavelength of 1200 nm measured in a stack composed of the transparent substrate and the one or more infrared absorbing layers is 10% or less.

According to the present invention, it is possible to sufficiently effectively cut an infrared light in a long wavelength range of 1200 nm or more while keeping a high transmittance for the visible light, and thereby correct the spectral sensitivity of a solid-state imaging device to the visibility of a human being so as to realize excellent color reproducibility. Further, according to the present invention, it is also possible to suppress warpage of a substrate and so on.

### BRIEF DESCRIPTION OF THE DRAWINGS

FIG. 1 is a cross-sectional view illustrating an infrared cut filter in an embodiment.

FIG. 2 is a cross-sectional view illustrating a modified example of the infrared cut filter in the embodiment.

FIG. 3 is a cross-sectional view illustrating another modified example of the infrared cut filter in the embodiment.

### DETAILED DESCRIPTION

Hereinafter, an embodiment of the present invention will be described. For description, drawings will be used and provided only for illustration, and the present invention is never limited by those drawings. Further, the drawings are schematic, and therefore it should be noted that the relationship between the thickness and the plane dimension, the thicknesses ratio, and so on are different from actual ones. Furthermore, in the following description, components having the same or substantially the same functions and configurations are given the same reference signs, and overlapping description thereof will be omitted.

As used herein, the term “light in an infrared wavelength range (or an infrared region)” means light with a wavelength of 800 nm or more, “light in a near-infrared wavelength range (or a near-infrared region)” means light with a wavelength of 670 nm or more and less than 800 nm, and “light in a visible wavelength range (or a visible region)” means light with a wavelength of 300 nm or more and less than 670 nm, unless otherwise stated.

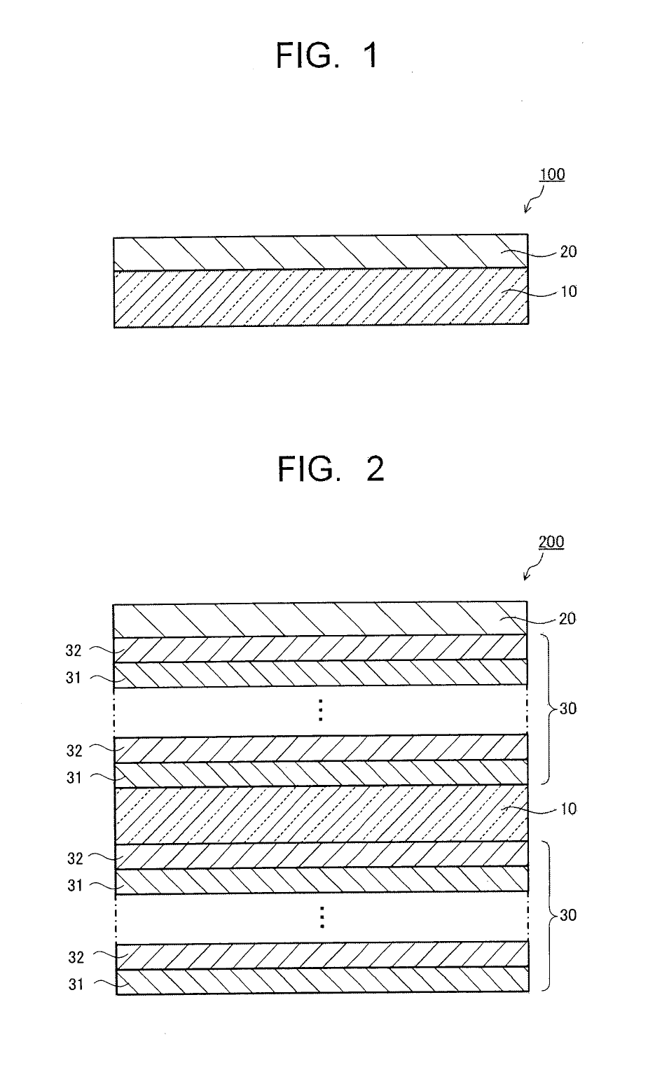

As illustrated in FIG. 1, an infrared cut filter in this embodiment (hereinafter, also referred to as this filter) 100 includes a transparent substrate 10, and an infrared absorbing layer 20 which is formed on at least one principal surface of the transparent substrate 10. As long as the infrared absorbing layer 20 is formed on one principal surface of the transparent substrate 10, the infrared absorbing layer 20 may be in contact with the transparent substrate 10 or another layer may be provided between the transparent substrate 10 and the infrared absorbing layer 20. As the another layer, a layer having an optical function, such as a dielectric multilayered film can be exemplified as will be described later.

In this filter, the transmittance of a stack obtained by stacking the transparent substrate and the infrared absorbing layer at a wavelength of 1200 nm is 10% or less. If the spectral characteristics of the stack composed of the transparent substrate and the infrared absorbing layer included in the infrared cut filter have the aforementioned characteristics, the whole infrared cut filter can attain a sufficient infrared cut ability. This makes it possible to correct the spectral sensitivity of a solid-state imaging device to the visibility of a human being. Note that in the case where the transparent substrate and the infrared absorbing layer are not adjacent to each other in this filter, each of the transparent substrate and the infrared absorbing layer is taken out for evaluation of the spectral characteristics of the stack obtained by stacking the transparent substrate and the infrared absorbing layer.

The transmittance means a value measured by a measurement method described in working examples.

### [Transparent Substrate]

The transparent substrate is not particularly limited as long as its light transmittance in the visible range is high. As the transparent substrate, a resin substrate and a glass substrate can be exemplified. Examples of the resin of the resin substrate include a polycarbonate-based resin, an acryl-based resin, a polyester-based resin, an epoxy-based resin, a melamine-based resin, a polyurethane-based resin, a polyimide-based resin, a polyamide-based resin, a norbornene-based resin, and so on. Examples of the glass substrate include soda lime glass, borosilicate glass, non-alkali glass, quartz glass, phosphate glass containing copper, and fluorophosphate glass containing copper (hereinafter, both of phosphate glass containing copper and fluorophosphate glass containing copper are collectively abbreviated as copper-containing glass herein). The “phosphate glass” is assumed to also include silicophosphate glass in which a part of the skeleton of the glass is made of SiO₂.

Examples of the shape of the transparent substrate include, but are not limited to, those having a cross section in a thickness direction of the transparent substrate in a rectangle, a square, a shape partially having a curve, and so on. Examples having the cross section in the shape of the rectangle and the square, include the transparent substrate of a window member of a camera and so on. Examples having the cross section in the shape partially having a curve include a spherical lens and an aspherical lens such as a convex lens and a concave lens.

As the transparent substrate 10, the glass substrate is preferable in terms of workability of the infrared cut layer and because of high transmittance in the visible range. Among glass substrates, copper-containing glass is preferable. The copper-containing glass has a high visible light transmittance and a low transmittance in the near-infrared region and the infrared region. Therefore, the glass substrate itself also has an infrared cutting effect and is preferable because the infrared cutting effect is improved in the infrared cut filter.

As the copper-containing glass, for example, the one having the following composition can be exemplified.

(1) Glass containing CuO: 0.5 to 7 parts by mass in terms of outer percentage expression, to 100 parts by mass of base glass made of, by mass %, 46 to 70% P₂O₅, 0.2 to 20% AlF₃, 0 to 25% ΣRF (R=Li, Na, K), 1 to 50% μR′F₂ (R′=Mg, Ca, Sr, Ba, Pb), and containing 0.5 to 32% F and 26 to 54% O.

(2) Glass made of, by mass% , 25 to 60% P₂O₅, 1 to 13% Al₂OF₃, 1 to 10% MgO, 1 to 16% CaO, 1 to 26% BaO, 0 to 16% SrO, 0 to 16% ZnO, 0 to 13% Li₂O, 0 to 10% Na₂O, 0 to 11% K₂O, 1 to 7% CuO, 15 to 40% ΣRO (R=Mg, Ca, Sr, Ba), 3 to 18% ΣR′₂O (R′=Li, Na, K) (where up to 39% molar quantity of O²⁻ ion is substituted by F).

(3) Glass containing, by mass %, 5 to 45% P₂O₅, 1 to 35% AlF₃, 0 to 40% ΣRF (R=Li, Na, K), 10 to 75% ΣR′F₂ (R′=Mg, Ca, Sr, Ba, Pb, Zn), 0 to 15% R″Fₘ (R″=La, Y, Cd, Si, B, Zr, Ta, and m is the number corresponding to valance of R″) (where up to 70% of the total amount of a fluoride can be substituted by an oxide), and 0.2 to 15% CuO.

(4) Glass containing, by cation %, 11 to 43% P⁵⁺, 1 to 29% Al³⁺, 14 to 50% ΣR cation (R=Mg, Ca, Sr, Ba, Pb, Zn), 0 to 43% ΣR′ cation (R′=Li, Na, K), 0 to 8% ΣR″ cation (R″=La, Y, Gd, Si, B, Zr, Ta), and 0.5 to 13% Cu²⁺, and further containing, by anion %, 17 to 80% F⁻.

(5) Glass containing, by cation %, 23 to 41% P⁵⁺, 4 to 16% A³⁺, 11 to 40% Li⁺, 3 to 13% Na⁺, 12 to 53% ΣR cation (R=Mg, Ca, Sr, Ba, Zn), and 2.6 to 4.7% Cu²⁺, and further containing, by anion %, 25 to 48% F⁻ and 52 to 75% O²⁻.

(6) Glass containing 0.1 to 5 parts by mass of CuO in terms of outer percentage to 100 parts by mass of base glass made of, by mass %, 70 to 85% P₂O₅, 8 to 17% Al₂O₃, 1 to 10% B₂O₃, 0 to 3% Li₂O, 0 to 5% Na₂O, 0 to 5% K₂O, where R₂O (R=Li, Na, K) is 0.1 to 5%, and SiO₂ is 0 to 3%.

Examples of commercial products of the aforementioned copper-containing glass include NF-50 (manufactured by AGC Techno Glass Co., Ltd., brand name), BG-60, BG-61 (which are manufactured by Schott AG, brand name), CD5000 (manufactured by HOYA Corporation, brand name) and so on.

Further, it is also possible to use glass obtained by making the aforementioned copper-containing glass further contain a predetermined metal oxide, for example, one kind or two or more kinds of Fe₂O₃, MoO₃, WO₃, CeO₂, Sb₂O₃, V₂O₅, and so on and thereby be given an ultraviolet absorbing property. Specifically, glass containing, to 100 parts by mass of the aforementioned copper-containing glass, at least one selected from a group consisting of Fe₂O₃, MoO₃, WO₃, and CeO₂, such as 0.6 to 5 parts by mass of Fe₂O₃, 0.5 to 5 parts by mass of MoO₃, 1 to 6 parts by mass of WO₃ and 2.5 to 6 parts by mass of CeO₂, or Fe₂O₃ and Sb₂O₃, such as 0.6 to 5 parts by mass of Fe₂O₃ and 0.1 to 5 parts by mass of Sb₂O₃, or two kinds of V₂O₅ and CeO₂, such as 0.01 to 0.5 parts by mass of V₂O₅ and 1 to 6 parts by mass of CeO₂, is used.

### [Infrared Absorbing Layer]

The infrared absorbing layer is a layer that contains an infrared absorbing compound. The stack composed of the transparent substrate and the infrared absorbing layer can reduce the transmittance for 1200 nm or more, and the infrared cut filter having the stack can exhibit an excellent infrared cutting effect.

Examples of the infrared absorbing layer include modes such as a mode in which the infrared absorbing compound is dispersed in a resin (hereinafter, referred to as a model), and a mode made of the infrared absorbing compound (hereinafter, referred to as a mode 2). Note that the infrared absorbing layer may be a single layer in either the mode 1 or the mode 2 or may be a multilayer composed of the mode 1 and the mode 2.

This filter preferably has an average transmittance for light in a range of a wavelength of 400 to 630 nm of 50% or more in order to increase the sensitivity for the visible range of the solid-state imaging device.

This filter preferably has a transmittance for light with a wavelength of 750 nm of 80% or less, more preferably 50% or less, and even more preferably 10% or less in order to cut light in the near-infrared region and increase the spectral sensitivity of the solid-state imaging device.

This filter preferably has a transmittance for light with a wavelength of 1000 nm of 7% or less, more preferably 5% or less, and even more preferably 3% or less in order to cut light in the infrared region and increase the spectral sensitivity of the solid-state imaging device. This filter preferably has a transmittance for light with a wavelength of 1200 nm of 10% or less, more preferably 8% or less, and even more preferably 5% or less in order to cut light in the infrared region and increase the spectral sensitivity of the solid-state imaging device. With such spectral characteristics, the filter can be preferably used as the infrared cut filter.

### (Infrared Absorbing Compound)

Examples of the infrared absorbing compound include an organic dye and an inorganic particle which are compounds absorbing light in the infrared region, in particular, at least light with a wavelength of 1200 nm. As the infrared absorbing compound, one kind selected from among the organic dyes and the inorganic particles can be solely used, or two or more kinds of them can be used in combination. In the case of using two or more kinds, the inorganic particle and the organic dye may be used in combination, or two or more different kinds in the inorganic particle or the organic dye may be used.

Examples of the organic dye include dyes such as a diimonium-based compound, a cyanine-based compound, a phthalocyanine-based compound, a naphthalocyanine-based compound, a dithiol metal complex-based compound, a dithiolene metal complex-based compound, a mercaptophenol metal complex-based compound, a mercaptonaphthol metal complex-based compound, an azo-based compound, a polymethine-based compound, a phthalide-based compound, a naphthoquinone-based compound, an anthraquinone-based compound, an indophenol-based compound, a pyrylium-based compound, a thiopyrylium-based compound, a squarylium-based compound, a croconium-based compound, a tetradehydocholine-based compound, a triphenylmethane-based compound, and an minium-based compound.

The organic dye is preferable in that it exhibits a high transmittance for the visible light. Further, a preferable organic dye is the one having a maximum absorption peak at a wavelength of 800 to 1300 nm, and preferably 900 to 1250 nm. Examples of the organic dye include a diimonium-based compound, a squarylium-based compound, a dithiolene metal complex-based compound, a mercaptophenol metal complex-based compound, a mercaptonaphthol metal complex-based compound, an aminium-based compound and so on. Among them, the diimonium-based compound is more preferable because of a high transmittance for the visible light and excellent weather resistance and so on. Accordingly, the present invention preferably contains at least one of a diimonium-based compound, a squarylium-based compound, a dithiolene metal complex-based compound, a mercaptophenol metal complex-based compound, a mercaptonaphthol metal complex-based compound, and an aminium-based compound, and more preferably contains a diimonium-based compound.

As a preferable example of the diimonium-based compound, for example, a salt compound of the following general formula [1] can be exemplified.

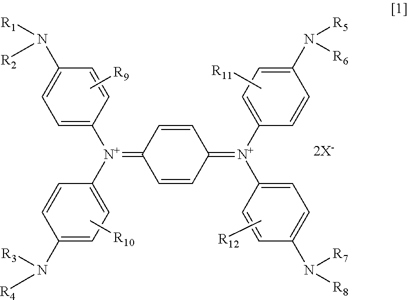

In the formula [1], X⁻ indicates an anion, and its examples include Cl⁻, Br⁻, I⁻, F⁻, ClO₄⁻, BF₄⁻, PF₆⁻, SbF₆⁻, CF₃SO₃⁻, CH₃C₆H₄SO₃, (R_{f}SO₂)₂N⁻, (R_{f}SO₂)₃C⁻ and so on. Among them, (R_{f}SO₂)₂N⁻ and (R_{f}SO₂)₃C⁻ are preferable, and (R_{f}SO₂)₂N⁻ is more preferable.

Here, Rf is a fluoroalkyl group with a carbon number of 1 to 4, preferably a fluoroalkyl group with a carbon number of 1 to 2, and more preferably a fluoroalkyl group with a carbon number of 1. When the carbon number is in the above-described range, the durability such as heat resistance and moisture resistance, and the solubility in a later-described organic solvent are excellent. Examples of such R_{f} include perfluoroalkyl groups such as —CF₃, —C₂F₅, —C₃F₇ and —C₄F₉, —C₂F₄H, —C₃F₆H, —C₂F_{g}H and so on.

In terms of the moisture resistance, the fluoroalkyl group is preferably a perfluoroalkyl group, and more preferably a trifluoromethyl group.

In the formula [1], R₁ to R₈ each represent a hydrogen atom, an alkyl group, an aryl group, an alkenyl group, or an alkynyl group, and may be the same with or different from each other. Further, R₉ to R₁₂ each represent a hydrogen atom, a halogen atom, an amino group, a cyano group, a nitro group, a carboxyl group, an alkyl group, or an alkoxy group, and may be the same with or different from each other.

Concrete examples of R₁ to R₈ include, as the alkyl group, a methyl group, an ethyl group, an n-propyl group, an iso-propyl group, an n-butyl group, an s-butyl group, an iso-butyl group, a t-butyl group, an n-pentyl group, a t-pentyl group, an n-amyl group, an n-hexyl group, an n-octyl group, a t-octyl group and so on.

These alkyl groups may have substituents such as an alkoxycarbonyl group, a hydroxyl group, a sulfo group, a carboxyl group and a cyano group. Concrete examples of R₁ to R₈ having the substituent include a 2-hydroxyethyl group, a 2-cyanoethyl group, a 3-hydroxypropyl group, a 3-cyanopropyl group, a methoxyethyl group, an ethoxyethyl group, a butoxyethyl group, and so on.

Examples of the aryl group include a phenyl group, a fluorophenyl group, a chlorophenyl group, a tolyl group, a diethylaminophenyl group, a naphthyl group, a benzyl group, a p-chlorobenzyl group, a p-phlorobenzyl group, a p-methylbenzyl group, a 2-phenylmethyl group, a 2-phenylpropyl group, a 3-phenylpropyl group, an a-naphthylmethyl group, a β-naphthylmethyl group, and so on. These aryl groups may have substituents such as a hydroxyl group, and a carboxy group.

Examples of the alkenyl group include a vinyl group, a propenyl group, a butenyl group, a pentenyl group, a hexenyl group, a heptenyl group, an octenyl group, and so on. These alkenyl groups may have substituents such as a hydroxyl group, and a carboxy group.

Examples of the alkynyl group include a propynyl group, a butynyl group, a 2-chlorobutynyl group, a pentynyl group, a hexynyl group, and so on. These alkynyl groups may have substituents such as a hydroxyl group, a carboxy group, and so on.

Among them, a linear chained or branched chained alkyl group with a carbon number of 4 to 6 is preferable. Setting the carbon number to 4 or more improves the solubility to the organic solvent, and setting the carbon number to 6 or less improves the heat resistance. The reason why the heat resistance is improved is possibly because the melting point of the diimonium-based dye increases.

Concrete examples of R₉ to R₁₂ include a hydrogen atom, a fluorine atom, a chlorine atom, a bromine atom, a diethylamino group, a dimethylamino group, a cyano group, a nitro group, a methyl group, an ethyl group, a propyl group, a trifluoromethyl group, a methoxy group, an ethoxy group, a propoxy group, and so on.

Examples of the commercial product of the diimonium-based compound of the above-described general formula [1] include Kayasorb IRG-022, Kayasorb MG-023, Kayasorb IRG-024, Kayasorb IRG-068, Kayasorb IRG-069, Kayasorb IRG-079, which are manufactured by Nippon Kayaku Co., Ltd., CIR-1081, CIR-1083, CIR-1085, CIR-RL (which are brand names) manufactured by Japan Carlit Co., Ltd., and so on.

The diimonium-based compound used in the present invention preferably has a molar absorbance coefficient εₘ near 1000 nm measured by the following measurement method of about 0.8×10⁴ to 1.5×10⁶ in order that the infrared absorbing layer 20 containing the diimonium-based compound sufficiently absorbs infrared light.

<Measurement Method of the Molar Absorbance Coefficient (εₘ)>

The diimonium-based compound is diluted with chloroform so that the sample concentration becomes 20 mg/L to produce a sample solution. The absorption spectrum of the sample solution is measured in a range of 300 to 1300 nm using a spectrophotometer, its maximum absorption wavelength (λₘₐₓ) is read, and a molar absorbance coefficient (εₘ) at the maximum absorption wavelength (λₘₐₓ) is calculated from the following formula.

ε=−log(I/I₀)

(ε: absorbance coefficient, I₀: light intensity before incident, I: light intensity after incident)

εₘ=ε/(c·d)

(εₘ: absorbance coefficient, c: sample concentration (mol/L), d: cell length)

The diimonium-based compound preferably has a purity of 98% or more or has a melting point of 210° C. or higher in terms of increasing the durability, and more preferably has a purity of 98% or more and has a melting point of 210° C. or higher.

Examples of the inorganic particle that can be used as the infrared absorbing compound include particles of ITO (In₂O₃-SnO₂-based), ATO (Sb₂O₃-SnO₂-based), lanthanum boride, sodium tungstate, potassium tungstate, rubidium tungstate, cesium tungstate, and so on. The inorganic particle is preferable in that it is excellent in thermal stability.

Because of high visible light transmittance and excellent absorption of light in the infrared region, particles of one or more kinds selected from a group consisting of sodium tungstate, potassium tungstate, rubidium tungstate, and cesium tungstate are more preferable as the inorganic particle. Among them, the particle of cesium tungstate is particularly preferable because of excellent absorption of light in the infrared region.

The inorganic particle can be used as a primary particle or a mixture of a secondary particle obtained by aggregation of primary particles and a primary particle. An average secondary particle diameter of the secondary particle is preferably 20 to 250 nm. Within this range, the inorganic particle when used in the infrared absorbing layer can sufficiently absorb light with 1200 nm. Further, when the inorganic particle is dispersed in a resin, the haze of the infrared absorbing layer can be reduced. The average secondary particle diameter is more preferably 20 to 200 nm, and even more preferably 20 to 150 nm.

As used herein, the term “average secondary particle diameter” means the number average aggregate particle diameter calculated by the dynamic light scattering particle size distribution measuring method. The average particle diameter is measured by using a dispersion liquid obtained by dispersing the inorganic particle in a dispersion medium and using a dynamic light scattering particle size distribution analyzer. As the dispersion medium, water or alcohol can be used. Further, measurement is performed with a solid content concentration of the dispersion liquid set to 5% by mass ratio.

An average primary particle diameter of the primary particle of the inorganic particle is preferably 5 to 100 nm. The inorganic particle having the average primary particle diameter within the above-described range is excellent in infrared light absorption characteristics.

As used herein, the term “average primary particle diameter” means a value obtained by measuring and averaging the particle sizes of 100 fine particles extracted at random from an observation image of specimen fine particles taken by a transmission electron microscope or a scanning electron microscope.

Examples of the shapes of the primary particle and the secondary particle of the inorganic particle include a spherical shape, a plate shape and so on. In terms of ease of handling in film formation of a resin film, the spherical shape is preferable.

### (Mode 1)

The mode 1 of the infrared absorbing layer will be described. In this mode, the infrared absorbing compound is dispersed in the transparent resin, so that adjustment of the film thickness of the infrared absorbing layer and adjustment of the spectral characteristics are easy. In the mode 1, the above-described organic dye or inorganic particle may be used as the infrared absorbing compound

In the mode 1, the thickness of the infrared absorbing layer (in the case of two or more infrared absorbing layers 20, the total of the thicknesses of the layers) is preferably 0.03 to 50 μm in average film thickness. By setting the thickness of the infrared absorbing layer 20 to 0.03 μm or more, the infrared absorption ability can be sufficiently exhibited, and by setting the thickness of the infrared absorbing layer 20 to 50 μm or less, (each) infrared absorbing layer 20 with a uniform film thickness can be formed. Further, from these points, the thickness of the infrared absorbing layer is more preferably 0.5 to 20 μm.

As used herein, the term “average film thickness” means, in the case of using a substrate with a film as a sample, an average step between the substrate surface and the film surface measured using a contact-type film thickness measurement apparatus for a film cross section obtained by removing a part of the film on the substrate, and is obtained by performing inclination correction to remove an installation error of the sample, applying a least square straight line equal in inclination to the bottom surface and the upper surface of the step for each scanning line, and setting the distance between two straight lines as a least square step in accordance with ISO 5436-1.

### (Transparent Resin)

As the transparent resin, various synthetic resins can be used. As the synthetic resins, thermoplastic resins such as a polyester resin, an acrylic resin, a polyolefin resin, a polycycloolefin resin, a polycarbonate resin, a polyamide resin, a polyurethane resin, and a polystyrene resin are preferable. Examples of commercial product of the resin to be used as the transparent resin include VYLON (brand name of a polyester resin) manufactured by Toyobo Co., Ltd., O-PET (brand name of a polyester resin) manufactured by Kanebo Ltd., ARTON (brand name of a polyolefin resin) manufactured by JSR Corporation, ZEONEX (brand name of a polycycloolefin resin) manufactured by Zeon Corporation, lupilon (brand name of a polycarbonate resin) manufactured by Mitsubishi Engineering-Plastics Corporation, PC-N1 (brand name of a polycarbonate resin) manufactured by Teijin Chemicals Ltd., HALSHYBRID IR-G204 (brand name of an acrylic resin) manufactured by Nippon Shokubai Co., Ltd.

The resin used in the mode 1 is preferably the one that exhibits an average transmittance in the range of 380 to 780 nm of 95% or more when measured in a thin film having a thickness of 10 μm.

As the transparent resin, a polyester resin is preferable. The polyester resin has advantages that it is high in transmittance for the visible light, excellent in weather resistance, excellent in solubility in various solvents, and capable of easily forming a resin film on the transparent substrate by dissolving it in a solvent and then coating with it by a wet coating method.

Among polyester resins, the one containing 1 to 10 mol %, preferably, 2 to 10 mol % of structural units derived from an aliphatic dicarboxylic acid is more preferable because it can improve the weather resistance. The reason why the weather resistance is improved is not necessarily clear, but is possibly because the dye can stably exist in the transparent resin when some interaction (for example, CH/π interaction) acts between the infrared absorbing compound dispersed in the transparent resin and the above-described structural units. When the structural units derived from an aliphatic dicarboxylic acid are less than 1 mol %, some interaction acting between the organic dye and the above-described structural units becomes insufficient, leading to a concern that the dye bleeds out by weather resistance evaluation. Besides, when the structural units are more than 10 mol %, the structure itself of the transparent resin greatly changes, so that the resin physical property values such as the molecular weight and the glass transition temperature change.

The above-described effects obtained from the interaction between the infrared absorbing compound and the structural units derived from an aliphatic dicarboxylic acid are more prominent in the case of using the organic dye, further prominent in the case of using the diimonium-based dye as the organic dye, and particularly prominent in the case of using the diimonium-based dye of the aforementioned general formula [1]. Examples of the commercial product of the resin satisfying the above conditions include VYLON103 (brand name) manufactured by Toyobo Co., Ltd. and so on.

The mode 1 of the infrared absorbing layer can be formed, for example, by preparing a coating liquid (hereinafter, written as a coating liquid I) made by dissolving or dispersing the infrared absorbing compound, the transparent resin, and components to be compounded as necessary in a medium, applying the coating liquid to the transparent substrate, and drying it.

As the medium for dissolving or dispersing the infrared absorbing compound, the transparent resin and so on therein, an organic solvent is preferable. Examples of the organic solvent include: alcohols such as methanol, ethanol, n-propyl alcohol, isopropyl alcohol, n-butyl alcohol, diacetone alcohol, ethyl cellosolve, methyl cellosolve, tridecyl alcohol, cyclohexyl alcohol, and 2-methyl cyclohexyl alcohol; glycols such as ethylene glycol, diethylene glycol, triethylene glycol, propylene glycol, dipropylene glycol, and glycerin; ketones such as acetone, methyl ethyl ketone, methyl isobutyl ketone, cyclopentanone, cyclohexanone, isophorone, and diacetone alcohol; amides such as N,N-dimethylformamide, and N,N-dimethylacetamide; sulfoxides such as dimethylsulfoxide; ethers such as tetrahydrofuran, dioxane, dioxolane, diethyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, ethylene glycol monomethyl ether acetate, ethylene glycol monoethyl ether acetate, and ethylene glycol monobutyl ether acetate; esters such as methyl acetate, ethyl acetate, and butyl acetate; aliphatic halogenated hydrocarbons such as chloroform, methylene chloride, dichloroethylene, carbon tetrachloride, and trichloroethylene; aromatic hydrocarbons such as benzene, toluene, xylene, monochlorobenzene, and dichlorobenzene, or aliphatic hydrocarbons such as n-hexane, n-heptane, and cyclohexanoligroin; and fluorine-based solvents such as tetrafluoropropyl alcohol, and pentafluoropropyl alcohol, and so on. One kind of these solvents can be solely used, or two or more kinds of them can be used in combination.

The coating liquid I may contain a surfactant. By containing the surfactant, the coating liquid I can improve in external appearance, in particular, voids caused by fine bubbles, dents due to adhesion of foreign substances or the like, crawling in a drying process and so on. The surfactant is not limited to a particular one, but any known ones such as cationic, anionic, nonionic surfactants can be used.

In the case of preparing, as the coating liquid I, a dispersion liquid made by dispersing the transparent resin, the infrared absorbing compound and so on in the medium, the solid content concentration is preferably 10 to 60 mass %. In the case of preparing, as the coating liquid I, a solution made by dissolving the transparent resin, the infrared absorbing compound and so on in the medium, the solute concentration is preferably 10 to 60 mass % to the whole coating liquid I. When the solid content concentration and the solute concentration are usually within the above range, the film thickness can be made uniform though depending on the coating method for the coating liquid I. If the solid content concentration and the solute concentration are too low, the viscosity of the coating liquid I is low and the film thickness of the infrared absorbing layer 20 therefore becomes small, resulting in an infrared absorbing layer 20 having a small content of the infrared absorbing compound and insufficient absorption of light with a wavelength of 1200 nm. On the other hand, if the solid content concentration and the solute concentration are too high, the dispersibility of the solid contents in the coating liquid I deteriorates, resulting in the possibility of increase in haze of the infrared absorbing layer 20. Further, the coating liquid I increases in viscosity, resulting in the possibility of failure to obtain the uniform film thickness in coating.

For applying the coating liquid I, for example, a coating method such as an immersion coating method, a spray coating method, a spinner coating method, a bead coating method, a wire bar coating method, a blade coating method, a roller coating method, a curtain coating method, a slit die coater method, a gravure coater method, a slit reverse coater method, a micro gravure method, a comma coater method, or an ink-jet method is usable.

For drying the coating liquid I, any known methods such as heat drying, and hot air drying can be used. Though depending on the boiling point of the solvent to be used, the drying temperature is normally 60 to 180° C., and preferably, 80 to 160° C., and the time is normally 5 to 120 minutes. The drying may be performed at a time, or may be performed divided in two times so that the temperature is increased or decreased stepwise. Further, as the pre-treatment of the drying, air drying in the atmosphere or drying under reduced pressure may be performed.

In the case of using the glass substrate as the transparent substrate, it is preferable to perform a pre-treatment on the glass substrate in applying of the coating liquid I. This can improve the adhesiveness between the glass substrate and the infrared absorbing layer. As a pre-treatment agent, aminosilanes such as γ-aminopropyltriethoxysilane, N-O-(aminoethyl)-γ-aminopropyltrimethoxysilane, N-β-(aminoethyl)-N-O-(aminoethyl)-γ-aminopropyltriethoxysilane, and γ-anilinopropyltrimethoxysilane, epoxysilanes such as γ-glycidoxypropyltrimethoxysilane, and β-(3,4-epoxycyclohexyl)ethyltrimethoxysilane, vinylsilanes such as vinyltrimethoxysilane, and N-β-(N-vinylbenzylaminoethyl)-γ-aminopropyltrimethoxysilane, γ-methacryloxypropyltrimethoxysilane, γ-chloropropyltrimethoxysilane, γ-mercaptopropyltrimethoxysilane, and the like can be used. One kind of them can be solely used, or two or more kinds of them can be used in combination.

In the mode 1 of the infrared absorbing layer, in addition to the above-described infrared absorbing compound, a color tone correcting dye, a leveling agent, an antistatic agent, a heat stabilizer, an antioxidant, a dispersing agent, a flame retardant, a lubricant, a plasticizer, an ultraviolet absorbent and the like having a maximum absorption wavelength of 300 to 800 nm may be contained in a range not impairing the effects of the present invention. As the ultraviolet absorbent, organic ultraviolet absorbents such as benzotriazole-based, benzophenone-based, cyclic iminoester-based ultraviolet absorbents are preferable in terms of the transmitting property to the visible light.

### (Mode 2)

A mode 2 of the infrared absorbing layer will be described. The infrared absorbing layer in this mode is composed of the inorganic particle. For example, in the case where the infrared cut filter has the transparent substrate and another resin layer other than the infrared absorbing layer, and the transparent substrate, the infrared absorbing layer and the other resin layer are provided in this order, the infrared absorbing layer, when in the mode 2, can improve the adhesiveness between the other resin layer and the transparent substrate. A surface roughness Ra of the layer in the mode 2 is preferably 30 to 500 nm. The layer in mode 2 may be provided directly on the transparent substrate, may be provided on the layer in mode 1 formed on the transparent substrate, or may be provided on the other resin layer.

As used herein, the term “surface roughness Ra” means an arithmetic mean height Ra defined in JIS B0601 (2001) measured using a contact-type film thickness measurement apparatus.

The infrared absorbing layer in the mode 2 can be formed by applying a coating liquid (hereinafter, written as a coating liquid II) obtained by dispersing the inorganic particle in a dispersion medium, onto the layer in the mode 1 formed on the transparent substrate or directly onto the transparent substrate, and then drying it to remove volatile components.

Examples of the dispersion medium of the coating liquid II include: ketones such as acetone, methyl ethyl ketone, methyl isobutyl ketone, and cyclohexanone; ethers such as tetrahydrofuran, 1,4-dioxane, and 1,2-dimethoxyethane; esters such as ethyl acetate, butyl acetate, and methoxyethyl acetate; alcohols such as methanol, ethanol, 1-propanol, 2-propanol, 1-butanol, 2-butanol, 2-methyl-1-propanol, 2-methoxyethanol, 4-methyl-2-pentanol, 2-butoxyethanol, 1-methoxy-2-propanol, and diacetone alcohol; hydrocarbons such as n-hexane, n-heptane, isooctane, benzene, toluene, xylene, gasoline, light oil, and kerosene; acetonitrile, nitromethane, water, and so on. One kind of them can be solely used, or two or more kinds of them can be used in combination.

The amount of the inorganic particle contained in the coating liquid II is preferably 0.1 to 50 mass %, and more preferably 0.5 to 20 mass %. The coating liquid II can contain as necessary a rheology adjuster, a leveling agent and so on as removable components similarly to the dispersion medium in a process of forming the infrared absorbing layer 20 in the mode 2.

For applying the coating liquid II, a coating method such as an immersion coating method, a cast coating method, a spray coating method, a spinner coating method, a bead coating method, a wire bar coating method, a blade coating method, a roller coating method, a curtain coating method, a slit die coater method, a gravure coater method, a slit reverse coater method, a micro gravure method, or a comma coater method is usable. Besides, a bar coater method, a screen printing method, a flexographic printing method, or the like is also usable.

### [Infrared Cut Filter]

In this filter, the infrared absorbing layer can be easily made uniform in film thickness in both of the mode 1 and the mode 2. Further, this filter can be reduced in number of layers of the dielectric multilayered film in order to satisfy the desired spectral characteristics. As a result of this, the productivity can be improved and the manufacturing cost can be reduced. Further, the infrared absorbing layer is composed of the resin layer or the infrared absorbing compound and therefore can be reduced in warpage of the substrate when the number of layers of the dielectric multilayered film is increased. Furthermore, the infrared absorbing layer exhibits the infrared cutting effect by absorbing the infrared ray, and therefore can reduce the incident angle dependence of the spectral transmittance.

Note that in the infrared cut filter 100 illustrated in FIG. 1, the infrared absorbing layer 20 is stacked on the transparent substrate 10, but the infrared absorbing layer 20 may be stacked on both principal surfaces of the transparent substrate 10, and another layer having an optical function such as a dielectric multilayered film may be provided between the transparent substrate 10 and the infrared absorbing layer 20. Such another layer having an optical function may be provided on another principal surface (a surface on a side opposite to the side where the infrared absorbing layer 20 is formed) of the transparent substrate 10, or may be provided on both principal surfaces of the transparent substrate 10.

FIG. 2 illustrates an example of an infrared cut filter having the other layer having an optical function. In an infrared cut filter 200 in this example, dielectric multilayered film 30 are provided, as layers having an optical function, on both principal surfaces of the transparent substrate 10.

The dielectric multilayered film 30 is made by alternately stacking low refractive index dielectric layers 31 and high refractive index dielectric layers 32, and functions as an infrared reflective film. As a material constituting the low refractive index dielectric layer, a material having a refractive index of 1.6 or less, preferably, 1.2 to 1.6 is used. Concretely, silica (SiO₂), alumina, lanthanum fluoride, magnesium fluoride, aluminum sodium hexafluoride, or the like is used. As a material constituting the high refractive index dielectric layer, a material having a refractive index of 1.7 or more, preferably, 1.7 to 2.5 is used.

Concretely, titania (TiO₂), zirconia, tantalum pentoxide, niobium pentoxide, lanthanum oxide, yttria, zinc oxide, zinc sulfide or the like is used. The refractive index means a refractive index to light with a wavelength of 550 nm.

The low refractive index dielectric layer and the high refractive index dielectric layer, each can be made to contain components different from the main components of each of the dielectric layers for the purpose of adjusting the refractive index of each of the layers. Examples of such components include SiO₂, Al₂O₃, CeO₂, FeO, Fe₂O₃, HfO₂, In₂O₃, MgF₂, Nb₂O₃, SnO₂, Ta₂O₃, TiO₂, Y₂O₃, ZnO, ZrO₂, NiO, ITO, ATO, MgO and so on.

The increase or decrease in refractive index due to containing the aforementioned additive is caused from the kind of the additive and the material composition of the layer to which the additive is to be added. For example, in the case where an additive with a refractive index lower than the refractive index of the layer is contained, the refractive index of the whole layer decreases, whereas in the case where an additive with a refractive index higher than the refractive index of the layer is contained, the refractive index of the whole layer increases.

Containing such additives changes the refractive index of the layer, and the above additives are added to the dielectric multilayered film so that the refractive index difference between the low refractive index dielectric layer and the high refractive index dielectric layer increases.

The dielectric multilayered film can be formed by a sputtering method, a vacuum deposition method, an ion beam method, an ion plating method, a CVD method, or the like. According to the methods, even when the number of stacked layers of the dielectric multilayered film is relatively large, the dielectric multilayered film can be relatively easily formed while the thickness is being controlled with high accuracy. Further, since the sputtering method and the ion plating method are so-called plasma atmosphere treatments, the adhesiveness of the dielectric multilayered film to the copper-containing glass substrate can be increased.

In the infrared cut filter, the dielectric multilayered films provided on both principal surfaces of the transparent substrate may have the same configuration or different configurations. More specifically, the dielectric multilayered film on the infrared absorbing layer side and the dielectric multilayered film on the opposite side thereto may be the same or different in the number of stacked layers, film thickness, material and so on.

Though the illustration is omitted, in the present invention, a complex multilayered film can also be provided which is constituted to have both a function of absorbing the infrared light and a function of reflecting the infrared light by alternately stacking an infrared absorbing film and a dielectric film, in place of or in addition to the above-described dielectric multilayered film. In the case of providing the complex multilayered film together with the dielectric multilayered film, the complex multilayered film and the dielectric multilayered film may be provided superposed only on one principal surface of the transparent substrate, the complex multilayered film and the dielectric multilayered film may be provided superposed on each of both principal surfaces of the transparent substrate, or the complex multilayered film may be provided on one principal surface and the dielectric multilayered film may be provided on the other principal surface. In the case of stacking them, the complex multilayered film and the dielectric multilayered film may be provided in this order or in the reversed order.

The infrared absorbing film referred to here is different from the infrared absorbing layer in the mode 2 composed of the inorganic particle. Examples of the material constituting the infrared absorbing film include indium, an indium-based composite oxide, tin, a tin-based composite oxide, zinc, a zinc-based composite oxide, and so on. Concrete examples include In₂O₃, ITO (indium tin oxide), Sn₂O₄, ZnO, AZO (zinc aluminum oxide), GZO (Ga-doped ZnO) and so on. On the other hand, examples of the material constituting the dielectric film include the same as those exemplified for the dielectric multilayered film. Specifically, silica, titania or the like is used. In the case of using ITO or the like as the infrared absorbing film, the dielectric film is preferably made of a material with a relatively low refractive index such as silica. This makes the whole complex multilayered film have a high reflection function to the infrared light.

Note that also the complex multilayered film can be made to contain an additive for the purpose of adjusting the refractive index of each layer. Examples of the additive include the same as those exemplified for the dielectric multilayered film. The complex multilayered film can be formed, similarly to the dielectric multilayered film, by a sputtering method, a vacuum deposition method, an ion beam method, an ion plating method, a CVD method, or the like. According to the methods, even when the number of stacked layers of the complex multilayered film is relatively large, the complex multilayered film can be relatively easily formed while the thickness is being controlled with high accuracy. Further, since the sputtering method and the ion plating method are so-called plasma atmosphere treatments, the adhesiveness of the complex multilayered film to the transparent substrate can be increased. Furthermore, when the complex multilayered films are provided on both principal surfaces sides of the transparent substrate, they may have the same configuration or different configurations.

In the present invention, providing the dielectric multilayered film or the complex multilayered film as described above makes it possible to enhance the cutting function to the infrared ray or increase the amount of the visible light incident on the infrared cut filter to thereby increase the transmittance for the visible light. Note that providing the dielectric multilayered film or the complex multilayered film causes concern of occurrence of problems such as substrate warpage, decrease in productivity and yield, and increase in manufacturing cost accompanying the decrease. However, since this filter has the infrared absorbing layer, the number of layers of the dielectric multilayered film or the complex multilayered film can be greatly reduced as compared with the case of providing the layers independently. Accordingly, it is possible to avoid or suppress the occurrence of problems such as substrate warpage, decrease in productivity and yield, and increase in manufacturing cost accompanying the decrease.

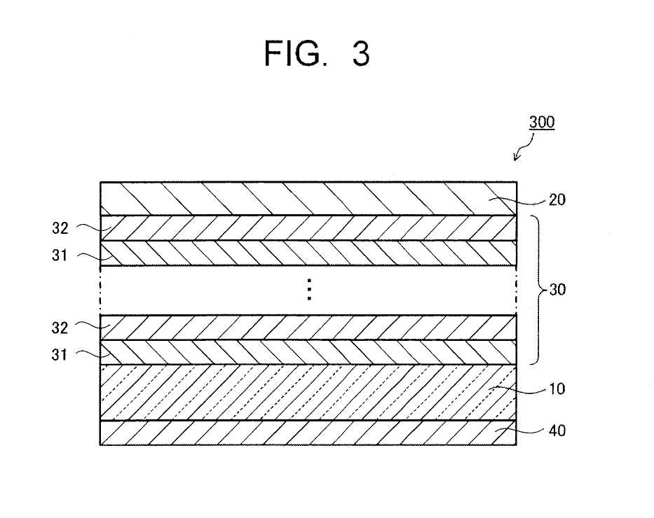

In the present invention, the anti-reflection film can be formed on the infrared absorbing layer on the transparent substrate, or on the principal surface on the opposite side to the principal surface on which the infrared absorbing layer is formed. FIG. 3 illustrates such an example in which an infrared absorbing layer 20 is provided on one principal surface of a transparent substrate 10 via a dielectric multilayered film 30 and an anti-reflection film 40 is provided on the other principal surface in an infrared cut filter 300 in this example.

The anti-reflection film has a function of preventing reflection of light incident on the infrared cut filter to thereby improve the transmittance and efficiently utilize the incident light, and can be formed by the conventionally known material and method. Concretely, the anti-reflection film is composed of a film of one or more layers of silica, titania, tantalum pentoxide, magnesium fluoride, zirconia, alumina or the like formed by a sputtering method, a vacuum deposition method, an ion beam method, an ion plating method, a CVD method, or the like, or silicate series, silicone series, methacrylate fluoride series, or the like formed by a sol-gel method, a coating method or the like.

As another layer having an optical function other than the above, a near-infrared absorbing layer that absorbs light in a near-infrared region can be exemplified. The near-infrared absorbing layer is a resin layer having a near-infrared absorbing dye. As the near-infrared absorbing dye, a compound having a maximum absorption peak at a wavelength of 680 to 730 nm is preferable. The infrared cut filter having the near-infrared absorbing layer is preferable because it has excellent near-infrared cut characteristics in addition to the infrared cut characteristics.

Examples of the near-infrared absorbing dye include a cyanine-based compound, a phthalocyanine-based compound, a naphthalocyanine-based compound, a dithiol metal complex compound, a diimonium-based compound, a polymethine-based compound, a phthalide compound, a naphthoquinone-based compound, an anthraquinone-based compound, an indophenol-based compound, a squarylium-based compound and so on. Among others, the squarylium-based compound is preferable because its absorption peak has a steep inclination.

Further, as the resin made to contain such a near-infrared absorbing dye, the resin exemplified for the mode 1 of the infrared absorbing layer can be preferably used.

The amount of the near-infrared absorbing dye to be contained in the near-infrared absorbing layer is preferably 0.1 to 15 parts by mass to 100 parts by mass of the resin, and more preferably, 0.3 to 10 parts by mass.

Note that description for the thickness and the forming method of the mode 1 of the infrared absorbing layer, a preferable range and so on are also applied to the thickness and the forming method of the near-infrared absorbing layer. More specifically, the thickness of the near-infrared absorbing layer is preferably the same thickness as that of the mode 1 of the infrared absorbing layer, and as the forming method for the near-infrared absorbing layer, the same method as the forming method for the mode 1 of the infrared absorbing layer can be used.

This filter can be used as an NIR filter of imaging apparatuses such as a digital still camera, a digital video camera, a monitoring camera, an on-vehicle camera, and a web camera, or of an automatic exposure meter, an NIR filter for PDP, and so on. This filter is preferably used, in particular, in the above-described imaging apparatuses, and can be disposed between an imaging lens and a solid-state imaging device, between the imaging lens and a window member of a camera, or both of them. Furthermore, as described above, this filter may have an infrared absorbing layer on one principal surface of the imaging lens, the window member of the camera or the like used as the transparent substrate 10.

Further, this filter can also be used, directly bonded to the solid-state imaging device of the imaging apparatus, a light receiving element of the automatic exposure meter, the imaging lens, the PDP or the like via an adhesive layer. Similarly, this filter can also be used, directly bonded to a glass window or a lamp of a vehicle (automobile or the like) via an adhesive layer.

Hitherto, the present invention has been described based on an embodiment and its modified examples. However, the present invention is not limited to described contents of the above-described embodiment, and can be changed as necessary without departing from the scope of the present invention.

### EXAMPLES

Next, the present invention will be described more concretely with examples, but the present invention is not construed as being limited by the examples. Examples 1 to 8, Examples 10 to 15 are examples of the present invention, and Examples 9, 16, 17 are comparative examples.

### Example 1

By dissolving 0.75 g of a polyester resin (manufactured by Toyobo Co., Ltd., brand name: VYLON103, indicated as polyester (A)) and 0.0145 g of a diimonium-based compound (manufactured by Nippon Kayaku Co., Ltd., brand name, IRG-069; a λₘₐₓ in a dichloromethane solvent of 1108 nm, a molar absorbance coefficients of 1.05×10⁵; indicated as diimonium (A)) in 4.25 g of cyclohexanone, a coating liquid (1) was prepared. The coating liquid (1) was applied to one principal surface of a glass substrate by the spin coating method and heated at 150° C. for 30 minutes to form into an infrared absorbing layer, whereby an infrared cut filter was obtained.

As the glass substrate, a substrate having a thickness of 0.3 mm and composed of a copper-containing fluorophosphate glass (manufactured by AGC Techno Glass Co., Ltd., brand name: NF-50; indicated as copper-containing glass) was used. An average film thickness of the infrared absorbing layer was 5.0 μm.

### Example 2

By dissolving 0.75 g of a polyester resin (manufactured by Toyobo Co., Ltd., brand name: VYLON280, indicated as polyester (B)) and 0.0250 g of the diimonium (A) in 4.25 g of cyclohexanone, a coating liquid (2) was prepared.

The coating liquid (2) was applied to one principal surface of a glass substrate by the spin coating method and heated at 150° C. for 30 minutes to form into an infrared absorbing layer, whereby an infrared cut filter was obtained. For the glass substrate, the same as in Example 1 was used.

An average film thickness of the infrared absorbing layer was 5.0 μm.

### Example 3

By dissolving 0.75 g of the polyester (A) and 0.0122 g of a diimonium-based dye (manufactured by Nippon Kayaku Co., Ltd., brand name: IRG-079; a λₘₐₓ in a dichloromethane solvent of 1103 nm, a molar absorbance coefficients of 1.05×10⁵; indicated as diimonium (B)) in 4.25 g of cyclohexanone, a coating liquid (3) was prepared.

The coating liquid (3) was applied to one principal surface of a glass substrate by the spin coating method and heated at 150° C. for 30 minutes to form into an infrared absorbing layer, whereby an infrared cut filter was obtained.

For the glass substrate, the same as in Example 1 was used.

An average film thickness of the infrared absorbing layer was 5.0 μm.

### Example 4

By mixing 0.75 g of the polyester (A) and 0.075 g of cesium tungstate (CWO, manufactured by Sumitomo Metal Mining Co., Ltd., brand name: YMF-02A, an average primary particle diameter of 13 nm), 0.025 g of 3-methacryloxypropyltrimethoxysilane (manufactured by Shin-Etsu Chemical Co., Ltd., brand name: KBM-503), and 4.25 g of cyclohexanone, a mixed solution was obtained. To 100 parts by mass of the mixed solution, 40 parts by mass of zirconia balls having a diameter of 0.5 mm, and wet grinding was performed by a ball mill for 2 hours. Then, the zirconia balls were removed, whereby a coating liquid (4) was obtained. The coating liquid (4) was applied to one principal surface of a glass substrate by the spin coating method and heated at 150° C. for 30 minutes to form into an infrared absorbing layer, whereby an infrared cut filter was obtained.

For the glass substrate, the same as in Example 1 was used.

An average film thickness of the infrared absorbing layer was 11 μm.

### Example 5

By mixing 0. 75 g of the polyester (A) and 0.075 g of tin-doped indium oxide (ITO, an average primary particle diameter of 13 nm), 0.025 g of 3-methacryloxypropyltrimethoxysilane (manufactured by Shin-Etsu Chemical Co., Ltd., brand name: KBM-503), and 4.25 g of cyclohexanone, a mixed solution was obtained. This mixed solution was treated by the same method as that of Example 4, whereby a coating liquid (5) was obtained.

The coating liquid (5) was applied to one principal surface of a glass substrate by the spin coating method and heated at 150° C. for 30 minutes to form into an infrared absorbing layer, whereby an infrared cut filter was obtained.

For the glass substrate, the same as in Example 1 was used.

An average film thickness of the infrared absorbing layer was 11 μm.

### Example 6

By dissolving 0.75 g of a polycarbonate resin (manufactured by Teijin Chemicals Ltd., brand name: Panlite TS-2020) and 0.0692 g of the diimonium (A) in 4.25 g of cyclohexanone, a coating liquid (6) was prepared.

The coating liquid (6) was applied to one principal surface of a glass substrate by the spin coating method and heated at 150° C. for 30 minutes to form into an infrared absorbing layer, whereby an infrared cut filter was obtained.

For the glass substrate, the same as in Example 1 was used.

An average film thickness of the infrared absorbing layer was 5.0 μm.

### Example 7

By dissolving 0.75 g of the polyester (A) and 0.0724 g of a dithiolene metal complex-based dye (manufactured by ORGANICA Co., Ltd., brand name: 17300; a λₘₐₓ in a dichloromethane solvent of 1069 nm, a molar absorbance coefficients of 3.07×10⁴; indicated as dithiolene metal complex) in 4.25 g of cyclohexanone, a coating liquid (7) was prepared.

The coating liquid (7) was applied to one principal surface of a glass substrate by the spin coating method and heated at 150° C. for 30 minutes to form into an infrared absorbing layer, whereby an infrared cut filter was obtained.

For the glass substrate, the same as in Example 1 was used.

An average film thickness of the infrared absorbing layer was 15.0

### Example 8

By dissolving 0.75 g of the polyester (A) and 0.0145 g of the diimonium (A) in 4.25 g of cyclohexanone, a coating liquid (8) was prepared.

The coating liquid (8) was applied to one principal surface of a glass substrate by the spin coating method and heated at 150° C. for 30 minutes to form into an infrared absorbing layer, whereby an infrared cut filter was obtained.

For the glass substrate, non-alkali glass having a thickness of 0.3 mm (manufactured by AGC Techno Glass Co., Ltd., brand name: AF45) was used.

An average film thickness of the infrared absorbing layer was 5.0 μm.

### Example 9

An infrared cut filter composed of only the same glass substrate as that in Example 1, without forming the infrared absorbing layer, was obtained.

### Example 10

On each of both principal surfaces (on a surface of a glass substrate where the infrared absorbing layer was not formed and on the infrared absorbing layer) of an infrared cut filter produced as in Example 1, a silica (SiO2; a refractive index of 1.45 (a wavelength of 550 nm)) layer and a titania (TiO2; a refractive index of 2.32 (a wavelength of 550 nm)) layer were alternately stacked by the sputtering method to form into a dielectric multilayered film (34 layers) made of the composition as listed in Table 1. Thereby, an infrared cut filter having the dielectric multilayered film was obtained.

TABLE 1

| | | Physical film |
|---|---|---|
| | Material | thickness (nm) |
| 1st layer | TiO₂ | 15.13 |
| 2nd layer | SiO₂ | 32.83 |
| 3rd layer | TiO₂ | 112.21 |
| 4th layer | SiO₂ | 169.24 |
| 5th layer | TiO₂ | 105.83 |
| 6th layer | SiO₂ | 172.00 |
| 7th layer | TiO₂ | 107.86 |
| 8th layer | SiO₂ | 170.47 |
| 9th layer | TiO₂ | 108.05 |
| 10th layer | SiO₂ | 174.63 |
| 11th layer | TiO₂ | 107.57 |
| 12th layer | SiO₂ | 171.41 |
| 13th layer | TiO₂ | 105.92 |
| 14th layer | SiO₂ | 171.41 |
| 15th layer | TiO₂ | 104.79 |
| 16th layer | SiO₂ | 163.65 |
| 17th layer | TiO₂ | 93.36 |
| 18th layer | SiO₂ | 145.28 |
| 19th layer | TiO₂ | 88.78 |
| 20th layer | SiO₂ | 145.71 |
| 21th layer | TiO₂ | 82.52 |
| 22th layer | SiO₂ | 141.75 |
| 23th layer | TiO₂ | 81.16 |
| 24th layer | SiO₂ | 141.97 |
| 25th layer | TiO₂ | 84.55 |
| 26th layer | SiO₂ | 139.37 |
| 27th layer | TiO₂ | 84.14 |
| 28th layer | SiO₂ | 139.91 |
| 29th layer | TiO₂ | 81.92 |
| 30th layer | SiO₂ | 145.51 |
| 31th layer | TiO₂ | 57.11 |
| 32th layer | SiO₂ | 148.83 |
| 33th layer | TiO₂ | 92.12 |
| 34th layer | SiO₂ | 76.65 |

### Example 11

A dielectric multilayered film (34 layers) was formed similarly to Example 10 on each of both principal surfaces of an infrared cut filter produced as in Example 4, whereby an infrared cut filter having the dielectric multilayered films was obtained.

### Example 12

A dielectric multilayered film (34 layers) was formed similarly to Example 10 on each of both principal surfaces of an infrared cut filter produced as in Example 4, whereby an infrared cut filter having the dielectric multilayered films was obtained.

### Example 13

By dissolving 0.75 g of the polyester (A) and 0.0122 g of a squarylium dye (a 2 in an acetone solvent of 695 nm) of the following formula [2] in 4.25 g of cyclohexanone, a coating liquid (13) was prepared.

The coating liquid (13) was applied to one principal surface of a glass substrate by the spin coating method and heated at 150° C. for 30 minutes to form into a near-infrared absorbing layer, and the coating liquid (1) was applied onto the near-infrared absorbing layer by the spin coating method and heated at 150° C. for 30 minutes to form into an infrared absorbing layer.

Then, a dielectric multilayered film (34 layers) was formed similarly to Example 10 each on the surface of the glass substrate where the infrared absorbing layer was not formed and on the infrared absorbing layer. Thereby, an infrared cut filter having the dielectric multilayered films was obtained.

As the glass substrate, a substrate having a thickness of 0.3 mm and composed of non-alkali glass (AF45) was used.

Average film thicknesses of the near-infrared absorbing layer and the infrared absorbing layer were 2.3 μm and 5.0 μm, respectively.

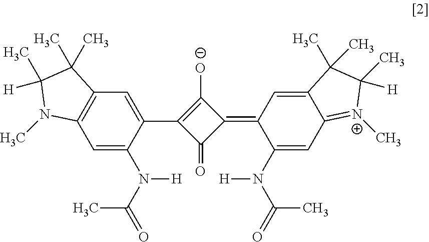 [SMILES: CC(=O)Nc1cc2c(cc1C1=C([O-])/C(=c3\cc4c(cc3NC(C)=O)=[N+](C)C(C)C4(C)C)C1=O)C(C)(C)C(C)N2C]

### Example 14

An infrared cut filter having the dielectric multilayered films was obtained as in Example 13 except that the coating liquid (4) was used in place of the coating liquid (1).

Average film thicknesses of the near-infrared absorbing layer and the infrared absorbing layer were 2.3 μm and 11 μm, respectively.

### Example 15

An infrared cut filter having the dielectric multilayered films was obtained as in Example 13 except that the coating liquid (5) was used in place of the coating liquid (1).

Average film thicknesses of the near-infrared absorbing layer and the infrared absorbing layer were 2.3 μm and 11 μm, respectively.

### Example 16

A dielectric multilayered film (34 layers) was formed similarly to Example 10 on each of both principal surfaces of a glass substrate, whereby an infrared cut filter having the dielectric multilayered films was obtained.

As the glass substrate, a substrate having a thickness of 0.3 mm and composed of copper-containing fluorophosphate glass (NF-50T) was used.

### Example 17

The coating liquid (13) was applied to one principal surface of a glass substrate by the spin coating method and heated at 150° C. for 30 minutes to form into a near-infrared absorbing layer. Then, a dielectric multilayered film (34 layers) was formed similarly to Example 10 on each of both surfaces thereof. Thereby, an infrared cut filter having the dielectric multilayered films was obtained.

As the glass substrate, a substrate having a thickness of 0.3 mm and composed of non-alkali glass (AF45) was used.

An average film thickness of the near-infrared absorbing layer was 2.3 μm.

For the infrared cut filters obtained in Examples 1 to 17, evaluations of the spectral characteristics (light transmittance) and the weather resistance were performed by the following methods. Their results are listed in Table 2 and Table 3. Note that Table 2 presents evaluation results of the spectral characteristics and the weather resistance of the stack of the glass substrate and the infrared absorbing layer (only the glass substrate in Examples 9, 16, 17) in each of the infrared cut filters in Examples 1 to 17, and Table 3 presents evaluation results of the spectral characteristics of each of the whole infrared cut filters in Examples 10 to 17.

### [Light Transmittance]

The average light transmittance in a wavelength range of 400 to 630 nm and the light transmittance in each of wavelengths of 750 nm, 1000 nm, and 1200 nm were measured using a spectrophotometer (manufactured by Hitachi, Ltd., Hitachi spectrophotometer U-4100). The measurement was performed on light incident from a direction perpendicular to a measurement surface (an incident angle of 0°) and on light incident from a direction inclined at 26° from the direction perpendicular to the measurement surface (an incident angle of 26°).

### [Weather Resistance]

The haze values before and after exposure to 150° C. for 24 hours were measured using a haze meter (manufactured by BYK Gardner Co., Ltd., haze-gard plus), and the variation between them was calculated from the following formula:

Haze value variation=H₁-H₀

wherein H₁ is the haze value after exposure and H₀ is the haze value before exposure.

TABLE 2

| | | Infrared absorbing layer | | | Transmittance (unit %) | | | | |
|---|---|---|---|---|---|---|---|---|---|
| | | Infrared absorbing | | Incident | 400-630 | | | | Haze |
| | Glass | compound | Resin | angle | nm | 750 nm | 1000 nm | 1200 nm | variation |
| Example 1 | Copper-containing | Diimonium (A) | Polyester (A) | 0° | 70.8 | 4.2 | 1.5 | 1.0 | 1.0 |
| | glass | | | 26° | 68.2 | 3.5 | 1.3 | 0.8 | |
| Example 2 | Copper-containing | Diimonium (A) | Polyester (B) | 0° | 67.7 | 4.9 | 1.2 | 1.0 | 1.4 |
| | glass | | | 26° | 66.8 | 3.8 | 0.9 | 0.9 | |
| Example 3 | Copper-containing | Diimonium (B) | Polyester (A) | 0° | 67.6 | 3.9 | 0.5 | 1.0 | 0.3 |
| | glass | | | 26° | 66.6 | 3.7 | 0.4 | 0.9 | |
| Example 4 | Copper-containing | CWO | Polyester (A) | 0° | 79.3 | 0.0 | 0.0 | 0.0 | 1.2 |
| | glass | | | 26° | 78.6 | 0.0 | 0.0 | 0.0 | |
| Example 5 | Copper-containing | ITO | Polyester (A) | 0° | 80.3 | 5.0 | 0.0 | 0.0 | 0.5 |
| | glass | | | 26° | 79.8 | 5.0 | 0.0 | 0.0 | |
| Example 6 | Copper-containing | Diimonium (A) | Polycarbonate | 0° | 64.7 | 4.2 | 0.1 | 1.0 | 2.6 |
| | glass | | | 26° | 64.3 | 4.2 | 0.1 | 1.0 | |
| Example 7 | Copper-containing | Dithiolene metal | Polyester (A) | 0° | 50.3 | 2.5 | 0.1 | 1.0 | 1.5 |
| | glass | complex | | 26° | 49.9 | 2.5 | 0.1 | 1.0 | |
| Example 8 | Non-alkali glass | Diimonium (A) | Polyester (A) | 0° | 83.1 | 75.8 | 0.0 | 0.0 | 1.0 |
| | | | | 26° | 82.7 | 74.3 | 0.0 | 0.0 | |
| Example 9 | Copper-containing | — | — | 0° | 82.3 | 7.0 | 7.5 | 24.2 | 1.0 |
| | glass | | | 26° | 81.5 | 6.8 | 7.3 | 23.8 | |
| Example 10 | Copper-containing | Diimonium (A) | Polyester (A) | 0° | 70.8 | 4.2 | 1.5 | 1.0 | 1.0 |
| | glass | | | 26° | 68.2 | 3.5 | 1.3 | 0.8 | |
| Example 11 | Copper-containing | CWO | Polyester (A) | 0° | 79.3 | 0.0 | 0.0 | 0.0 | 1.2 |
| | glass | | | 26° | 78.6 | 0.0 | 0.0 | 0.0 | |
| Example 12 | Copper-containing | ITO | Polyester (A) | 0° | 80.3 | 5.0 | 0.0 | 0.0 | 0.5 |
| | glass | | | 26° | 79.8 | 5.0 | 0.0 | 0.0 | |
| Example 13 | Non-alkali glass | Diimonium (A) | Polyester (A) | 0° | 83.1 | 75.8 | 0.0 | 0.0 | 1.0 |
| | | | | 26° | 82.7 | 74.3 | 0.0 | 0.0 | |
| Example 14 | Non-alkali glass | CWO | Polyester (A) | 0° | 86.9 | 66.0 | 5.3 | 0.0 | 0.8 |
| | | | | 26° | 85.9 | 65.4 | 5.1 | 0.0 | |
| Example 15 | Non-alkali glass | ITO | Polyester (A) | 0° | 90.3 | 83.2 | 53.6 | 0.0 | 0.7 |
| | | | | 26° | 89.7 | 82.8 | 52.8 | 0.0 | |
| Example 16 | Copper-containing | — | — | 0° | 82.3 | 7.0 | 7.5 | 24.2 | 1.0 |
| | glass | | | 26° | 81.9 | 6.8 | 7.3 | 23.9 | |
| Example 17 | Non-alkali glass | — | — | 0° | 98.1 | 97.8 | 98.2 | 98.1 | 0.1 |
| | | | | 26° | 97.9 | 97.9 | 97.9 | 97.9 | |

TABLE 3

| | | Near-Infrared | | | | | | | | | |
|---|---|---|---|---|---|---|---|---|---|---|---|
| | | absorbing layer | | Infrared | | | | | | | |
| | | Near- | | absorbing layer | | | | | | | |
| | | Infrared | | Infrared | | Dielectric | | Transmittance (unit %) | | | |
| | | absorbing | | absorbing | | multilayered | Incident | 400-630 | | | |
| | Glass | compound | Resin | compound | Resin | film | angle | nm | 750 nm | 1000 nm | 1200 nm |
| Example | Copper- | — | — | Diimonium | Polyester | Exist | 0° | 74.0 | 0.0 | 0.0 | 1.0 |
| 10 | containing glass | | | (A) | (A) | | 26° | 75.2 | 0.0 | 0.0 | 1.0 |
| Example | Copper- | — | — | CWO | Polyester | Exist | 0° | 78.1 | 0.0 | 0.0 | 0.0 |
| 11 | containing glass | | | | (A) | | 26° | 78.3 | 0.0 | 0.0 | 0.0 |
| Example | Copper- | — | — | ITO | Polyester | Exist | 0° | 79.1 | 0.0 | 0.0 | 0.0 |
| 12 | containing glass | | | | (A) | | 26° | 79.3 | 0.0 | 0.0 | 0.0 |
| Example | Non-alkali glass | Squarylium | Polyester | Diimonium | Polyester | Exist | 0° | 79.1 | 0.0 | 0.0 | 0.0 |
| 13 | | | (A) | (A) | (A) | | 26° | 79.6 | 0.0 | 0.0 | 0.0 |
| Example | Non-alkali glass | Squarylium | Polyester | CWO | Polyester | Exist | 0° | 84.7 | 0.0 | 0.0 | 1.0 |
| 14 | | | (A) | | (A) | | 26° | 85.2 | 0.0 | 0.0 | 1.0 |
| Example | Non-alkali glass | Squarylium | Polyester | ITO | Polyester | Exist | 0° | 88.6 | 0.0 | 0.0 | 0.0 |
| 15 | | | (A) | | (A) | | 26° | 89.3 | 0.0 | 0.0 | 0.0 |
| Example | Copper- | — | — | — | — | Exist | 0° | 82.9 | 0.0 | 0.0 | 10.9 |
| 16 | containing glass | | | | | | 26° | 83.5 | 0.0 | 0.0 | 40.2 |
| Example | Non-alkali glass | Squarylium | Polyester | — | — | Exist | 0° | 96.6 | 0.0 | 0.0 | 8.8 |
| 17 | | | (A) | | | | 26° | 97.1 | 0.0 | 0.0 | 38.5 |

As is clear from Tables 2, 3, each of the infrared cut filters in Examples 1 to 8, 10 to 15, which has a transparent substrate and one or more infrared absorbing layers containing the infrared absorbing compound on at least one principal surface of the transparent substrate and has a transmittance of a stack composed of the transparent substrate and the one or more infrared absorbing layers at a wavelength of 1200 nm of 10% or less, can sufficiently effectively cut the infrared light in a long wavelength range of 1200 nm or more while keeping a high transmittance for the visible light. Therefore, a solid-state imaging device using the optical filter cuts the infrared light and thereby becomes possible to correct the spectral sensitivity to the normal visibility of a human being and obtain an excellent color reproducibility.

The infrared cut filter of the present invention has a high transmittance for light in a visible wavelength range and has an excellent cutting effect also to the infrared light in a long wavelength range of 1200 nm or more, and is thus useful as an infrared cut filter responding to severe requirements in recent years.

What is claimed is:

1. An infrared cut filter comprising a transparent substrate and one or more infrared absorbing layers on at least one principal surface of the transparent substrate,
wherein the infrared absorbing layer is a layer containing an organic dye or an inorganic particle in a transparent resin or a layer composed of an inorganic particle, and
wherein a transmittance at a wavelength of 1200 nm measured in a stack composed of the transparent substrate and the one or more infrared absorbing layers is 10% or less.

2. The infrared cut filter according to claim 1,
wherein the transparent substrate is a glass substrate.

3. The infrared cut filter according to claim 2,
wherein the glass substrate is a copper-containing glass substrate using phosphate glass or fluorophosphate glass as a base material and containing copper in the base material.

4. The infrared cut filter according to claim 1,
wherein the organic dye is at least one selected from a group consisting of a diimonium-based compound, a squarylium-based compound, a dithiolene metal complex-based compound, a mercaptophenol metal complex-based compound, a mercaptonaphthol metal complex-based compound, and an aminium-based compound.

5. The infrared cut filter according to claim 4,
wherein the organic dye comprises a diimonium-based compound.

6. The infrared cut filter according to claim 1,
wherein the inorganic particle is at least one selected from a group consisting of a sodium tungstate particle, a potassium tungstate particle, a rubidium tungstate particle, and a cesium tungstate particle.

7. The infrared cut filter according to claim 6,
wherein the inorganic particle is a cesium tungstate particle.

8. The infrared cut filter according to claim 1,
wherein the transparent resin comprises a polyester resin.

9. The infrared cut filter according to claim 8,
wherein the polyester resin contains 1 to 10 mol % of structural units derived from an aliphatic dicarboxylic acid.

10. The infrared cut filter according to claim 1, further comprising
a dielectric multilayered film formed on at least one principal surface of the transparent substrate.

11. The infrared cut filter according to claim 1, further comprising
one or more near-infrared absorbing layers containing a near-infrared absorbing compound, on at least one principal surface of the transparent substrate.

12. The infrared cut filter according to claim 1, further comprising
an anti-reflection film constituting an uppermost surface on at least one principal surface of the transparent substrate.
